(19) United States
(12) Patent Application Publication
(10) Pub. No.: US 2016/0066678 A1
(43) Pub. Date: Mar. 10, 2016

(54) BAND SUPPORT STRUCTURE FOR WEARABLE DEVICE

(71) Applicant: Filip Technologies, Inc., New York, NY (US)

(72) Inventors: Gregory Wolos, Cambridge, MA (US); Timothy R. Proulx, Nashua, NH (US); Ari T. Adler, Cambridge, MA (US); Dirk Ahlgrim, Boston, MA (US)

(21) Appl. No.: 14/479,219

(22) Filed: Sep. 5, 2014

(51) Int. Cl. A45F 5/00; H01Q 1/48; H01Q 1/27

(52) U.S. Cl. CPC A45F 5/00; H01Q 1/273; H01Q 1/48; A45F 2005/008

(57) ABSTRACT

This disclosure relates to support structures for bands for wearable devices. In an aspect, the support structure includes an inner member and an outer member. The inner member includes a curved portion and a flat portion. The outer member includes a curved portion and an interface member that attaches to the flat portion of the inner member. The inner member and the outer member form a cavity between them, and the cavity can be filled with a fill member. The inner and outer members can slide with respect to each other when flexed. An antenna can be wrapped around the inner member and the outer member.

### BACKGROUND

Devices capable of wireless communication have become pervasive in society. “Smart” portable devices such as smartphones and tablet computers are nearly ubiquitous. These devices are typically able to connect to wireless networks using a variety of radiofrequency standards, such as Wi-Fi, cellular, and Bluetooth.

There have been attempts to develop wearable devices that can offer much of the utility of these smart devices in a package that can be worn on the body. Many wearable devices, however, are unable to strike a sufficient balance between comfort, flexibility, and support for the electronics that are necessary for such devices. Accordingly, there is a need in the art for a band for a wearable device that is flexible and comfortable, while retaining the structural integrity necessary to support the electronic components and antennas used with such a device.

### SUMMARY

It is to be understood that both the following general description and the following detailed description are exemplary and explanatory only and are not restrictive, as claimed. Provided is a support structure for a band for a wearable device.

In one aspect, a support structure for a band for a wearable device is provided. The support structure can include an inner member that includes a curved portion and a flat portion. The support structure can also include an outer member that includes a curved portion and an interface member that can be attached to the flat portion of the inner member. The inner member and the outer member can form a cavity between them. The support structure can also include a fill member that is configured to fill the cavity between the inner member and the outer member. The wearable device can be configured to be worn on a wrist.

The support structure can include a band that surrounds the support structure. The outer member can include ribs that maintain the cavity between the inner member and the outer member. The outer member can also include ribs that engage the fill member. The inner member can include an aperture that increases the flexibility of the inner member. The ribs on the outer member can be configured to engage with the aperture on the inner member.

The support structure can also include an antenna that is wrapped around the inner member and the outer member. The antenna can include a first portion that includes a ground plane and a second portion that includes transmitting elements. The ground plan can be substantially disposed on the inner member, and the transmitting elements can be substantially disposed on the outer member.

In another aspect, a support structure for a band for a wearable device is provided. The support structure can include a band configured to allow the device to be worn. The band can include a support assembly. The support assembly can include an inner member that is coupled to an outer member, where the inner member and the outer member are in a spaced apart relationship and coupled together on one end. The support assembly can also include an antenna disposed on the inner member and the outer member, wherein the ground plane of the antenna is disposed on the inner member and the transmitting elements of the antenna are disposed on the outer member. The antenna can include a flexible printed circuit board. The support structure can also include a fill member that occupies the cavity between the inner member and the outer member. The wearable device can be configured to be worn on a wrist.

The outer member can include ribs that maintain a minimum distance between the inner member and the outer member. The outer member can include ribs that engage the fill member. The inner member can include an aperture that increases the flexibility of the inner member. The outer member can also include a rib configured to engage with an aperture on the inner member. The inner member and the outer member may be coupled along only one edge. The inner member and the outer member can be configured so that the inner member and the outer member can move laterally with respect to one another.

In another aspect, a support structure for a band for a wearable device is provided. The support structure can include a band that is configured to allow the device to be worn. The band can include a support assembly. The support assembly can include an inner member coupled to an outer member. The inner member and the outer member can be disposed in a spaced apart relationship and coupled together along only one edge such that they can move laterally with respect to one another. The outer member can include ribs that maintain a minimum distance between the inner member and the outer member and define a cavity. The cavity can include a fill member that engages the ribs. The support assembly can also include a flexible printed circuit board that includes an antenna. The antenna can be disposed on the inner member and the outer member, where the ground plane of the antenna can be disposed on the inner member and the transmitting elements of the antenna can be disposed on the outer member.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the apparatus:

FIG. 1 is a perspective view of a band of a wearable device in accordance with an exemplary embodiment of the apparatus described herein;

FIG. 2 is a diagram of the components of a band support structure for a wearable device in accordance with an exemplary embodiment of the apparatus described herein;

FIG. 3 is a perspective view of an inner member of a band support structure for a wearable device in accordance with an exemplary embodiment of the apparatus described herein;

FIG. 4 is a perspective view of an outer member of a band support structure for a wearable device in accordance with an exemplary embodiment of the apparatus described herein;

FIG. 5 is a perspective view of a fill member of a band support structure for a wearable device in accordance with an exemplary embodiment of the apparatus described herein; and

FIG. 6 is a perspective view of an antenna that can be used with a band support structure for a wearable device in accordance with an exemplary embodiment of the apparatus described herein.

### DETAILED DESCRIPTION

Before the present apparatus is disclosed and described, it is to be understood that the claimed apparatus is not limited to specific components, configurations, or to particular implementations described herein. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the distribution points of each of the ranges are significant both in relation to the other distribution point, and independently of the other distribution point.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to make the described apparatus. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all apparatuses. This applies to all aspects of this application.

The present apparatus may be understood more readily by reference to the following detailed description of preferred embodiments and the examples included therein and to the Figures and their previous and following description.

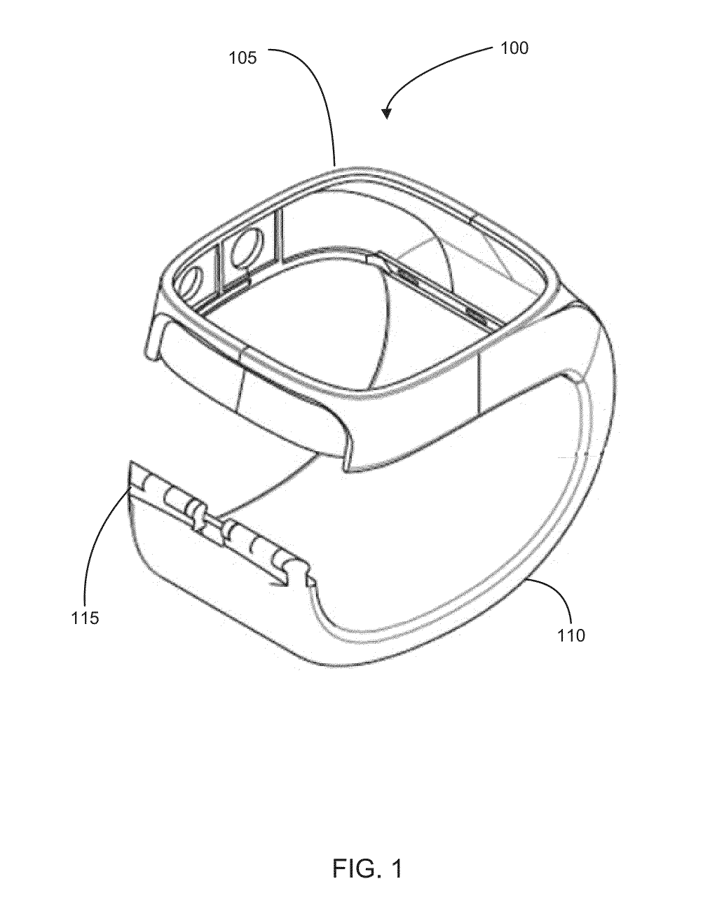

Turning now to FIG. 1, a perspective view of a wearable device in accordance with an exemplary embodiment of the apparatus described herein is shown. In an exemplary embodiment, the wearable device 100 is a wrist-borne device. In alternative exemplary embodiments, the apparatus may be worn on other areas of the body, such as the ankle, waist, neck, or around other parts of the legs and/or torso. As one of skill in the art would understand, modifying the wearable device 100 to fit various parts of the body involves modifying the size and configuration of the band 110 so as to be the appropriate size and have the appropriate rigidity for a given application. Such modifications are within the scope of the present disclosure.

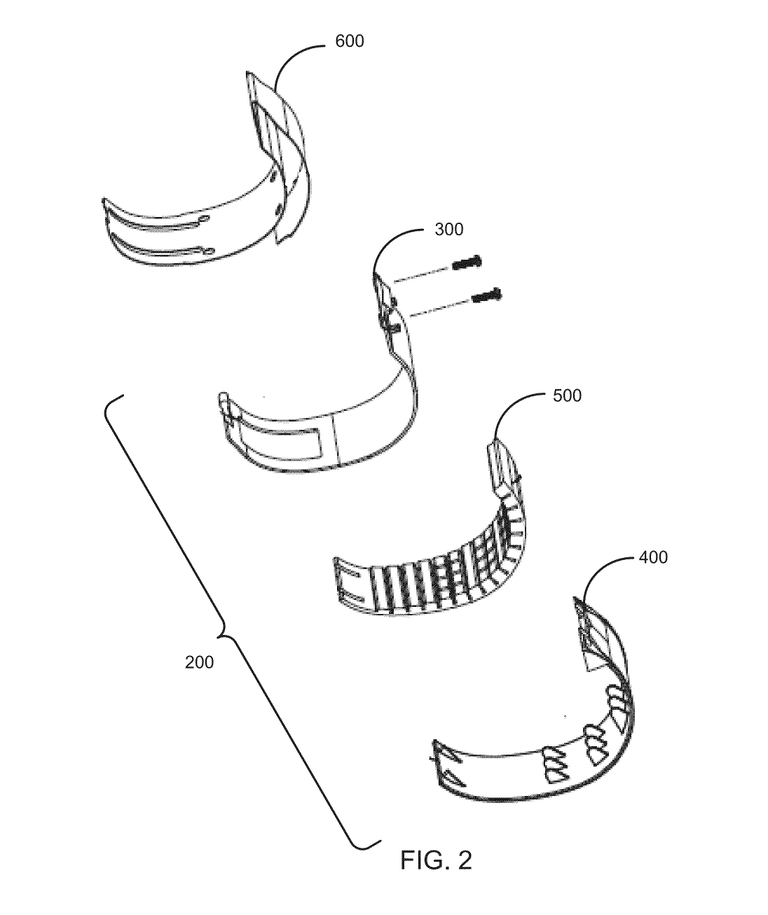

The wearable device 100 includes a band 110 and a housing 105. The band 110 can be made from a suitable material and configured such that it can hold the wearable device 100 in place on the wrist. By way of example, the band 110 can be made from a thermoplastic elastomer (TPE). In alternative exemplary embodiments, the band 110 can be made from other suitable materials, such as cloth, canvas, rubber, or silicone. The band 110 in the exemplary embodiment can be configured as a solid, moderately flexible band that is approximately C-shaped as shown in FIG. 1, however, alternative configurations of the band 110 are contemplated in this disclosure. For example, the band 110 can form a complete loop so long as the loop is either sufficiently flexible or detachable so as to be able to be put in place on the wrist. In the exemplary embodiment of the band 110 set forth in FIG. 1, the band 110 ends with a connector 115 that can be coupled to extensions of various size to modify the size of the band 110. U.S. patent application Ser. No. 14/011,352, which is incorporated by reference in its entirety, describes alternative configurations for the band 110. In accordance with an exemplary embodiment, the band 110 is also configured to contain an antenna. The configuration of the antenna within the band 110 will be discussed in greater detail with respect to FIGS. 2-4.

The band 110 is coupled to a housing 105. The housing 105 is configured to hold a communication device. By way of example, the communication device can be a device such as the device disclosed in U.S. patent application Ser. No. 14/011,352 and PCT Application Nos. PCT/US2013/020368 and PCT/US2013/020355, which are incorporated by reference herein. In an alternative exemplary embodiment, however, the communication device can be any type of communication device, such as a miniaturized smartphone, fitness monitor, pedometer, biometrics sensor, GPS device, or any other device that can take advantage of the antenna in the band 110. The size and shape of the housing 105 shown in FIG. 1 is for illustrative purposes only and may be modified so as to suitably hold the chosen device.

Turning now to FIG. 2, the internal support structure of the band 110 is shown. In an exemplary embodiment, the internal support structure of the band includes a support assembly 200. The exemplary support assembly 200 is made up of three members: an inner member 300, an outer member 400, and a fill member 500. The inner member 300, outer member 400, and fill member 500 are coupled together to provide support to the band 110. The support assembly also provides a structure on which an antenna 600 can be attached, all of which can fit within the band 110.

In an exemplary embodiment, the inner member 300 and the outer member 400 are coupled together on one end. In this example, the inner member 300 is connected to the outer member 400 along the flat portion 305 of the inner member 305 using screws 320. The inner member and the outer member form a cavity between them. By attaching the inner member 300 to the outer member 400 on only one end, the members can slip past one another when the band 110 is flexed. This arrangement provides more strength than a single member, while allowing the band to have more flexibility than it would have if the inner member 300 and the outer member 400 were connected on all sides. This arrangement also allows flexibility while maintaining a gap between the inner and outer members.

In an exemplary embodiment, the fill member 500 is interposed between the inner member 300 and the outer member 400. The fill member 500 can provide additional dielectric for tuning the antenna performance. In an exemplary embodiment, the fill member 500 is molded flat from a flexible material such as elastomer. The fill member 500 can then be bent so as to fit into place on the outer member 400.

Although the members are described as an inner member 300 and an outer member 400, these conventions are for convenience only and are used to distinguish the exemplary members as shown in FIG. 2 from one another. In this exemplary embodiment, the inner member 300 is situated closest to the person wearing the device while the outer member 400 is situated away from the wearer. As a person of skill in the art would understand, however, different arrangements of the inner member 300 and outer member 400 are possible within the scope and the teaching of this document.

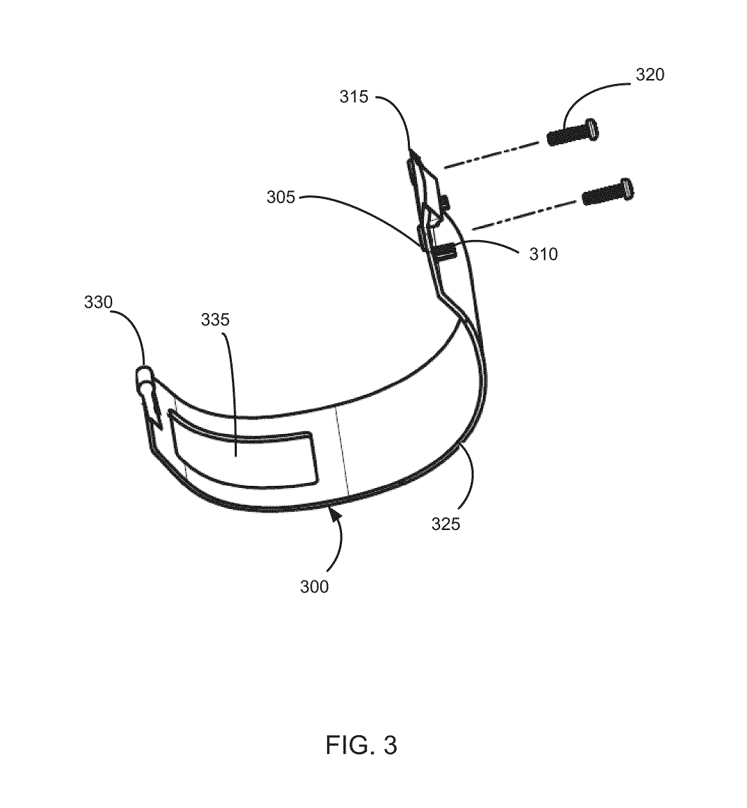

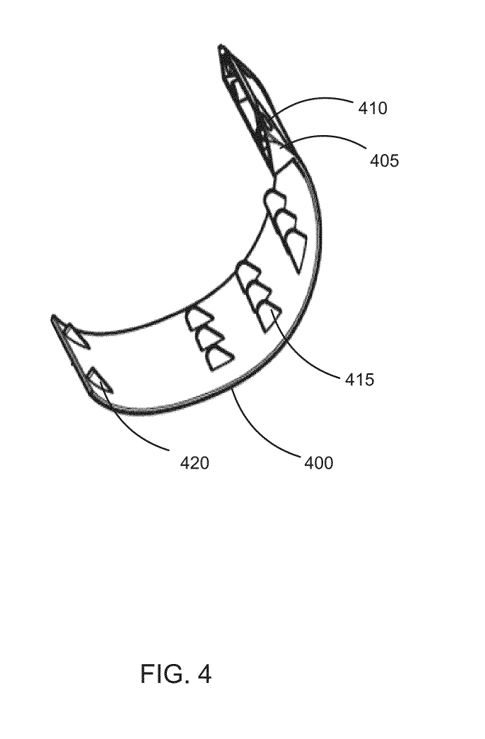

Turning now to FIG. 3, a perspective view of the inner member 300 is provided. The exemplary inner member may be made from polycarbonate material, but may be made from any suitably strong, yet flexible material, such as cloth, canvas, rubber, or silicone. The exemplary inner member includes a flat portion 305 and curved portion 325. The exemplary flat portion 305 is sized and oriented so as to mate with an interface member 405 of the outer member 400 (described in FIG. 4). The exemplary curved portion 325 is generally sized and shaped for the application for which the device is anticipated to be used. By way of example, the exemplary device 100 shown in FIG. 1 may be worn around the wrist or ankle of an individual, and the curved portion 325 may be sized and shaped for that application. As one of skill in the art would understand, however, other shapes of the curved portion 325 are contemplated and within the scope of the invention. For example, the curved portion 325 could have a more severe bend with the intention that it be hung or clipped over an external support such as a strap, bar, or article of clothing.

The flat portion 305 may include fastener receptacles 310 that can accept fasteners 320 such as screws, bolts, or other attachment members that aid in fastening the inner member 300 to the outer member 400. As one of skill in the art would understand, however, the use of fasteners 320 is merely an exemplary approach to attaching the inner member 300 to the outer member 400, and the same result may be accomplished by means of fasteners, fusing, ultrasonic welding, epoxies, and other means of attaching known to those of skill in the art.

In an exemplary embodiment, the inner member 300 may have an attachment coupling 330. The attachment coupling 330 may be use to secure the support assembly 200 in place in the band 110 (not shown). In an alternative exemplary embodiment, the attachment coupling may extend beyond the band 110 and interface with accessories for the band 110 such as extenders and latches that couple the end of the band with the attachment coupling 330 to the housing 105. In addition, because the attachment coupling 330 may be made from a more rigid material than the band 110, it can provide structural support for accessories that are made from softer elastomeric materials like those that can be used with the exemplary band 110.

The exemplary inner member may also have an aperture 335. The aperture 335 can be configured to receive corresponding aligning members 420 from the outer member 400 (described with respect to FIG. 4) and can assist in maintaining the orientation between the inner member 300 and the outer member 400. In an exemplary embodiment, the aperture 335 and aligning members 420 are configured so as to be movably coupled to one another so as to allow some freedom of movement of the inner member 300 with respect to the outer member 400 without allowing the two members to substantially change their relative orientation. In an alternative exemplary embodiment, the aperture 335 may be configured so as to lock in place with the aligning members 420, providing for greater stability between the inner member 300 and the outer member 400, but less flexibility. The exemplary aperture 335, in conjunction with the aligning members, can also provide a maximum distance over which the aligning members 420 can slide with respect to the inner member 300. In this way, the combination of the aperture 335 and the aligning members 420 create a limit on the amount the assembly 100 can flex. Such a maximum can, for example, prevent over flexing of either the inner or outer member.

The aperture 335 also removes some material from the inner member 300. By removing this material, the inner member 300 provides greater flexibility for the wearer. In an exemplary embodiment, the aperture 335 is roughly rectangular in shape and disposed in the curved portion 325 of the inner member. As one of skill in the art would understand, however, the size and shape of the aperture 335 can be modified to provide more or less additional flexibility over an inner member that lacks an aperture 335.

Turning now to FIG. 4, a perspective view of the outer member 400 is provided. The outer member 400 is configured to generally match the shape of the inner member 300. The outer member 400 includes an interface member 405 that, in an exemplary embodiment, is shaped so as to mate with the flat portion 305 of the inner member (shown in FIG. 3). The interface member 405 may also include one or more fastener apertures 410 to allow fasteners 320 (shown in FIG. 3) to pass through the interface member 405 and attach it to the flat portion of the inner member 300.

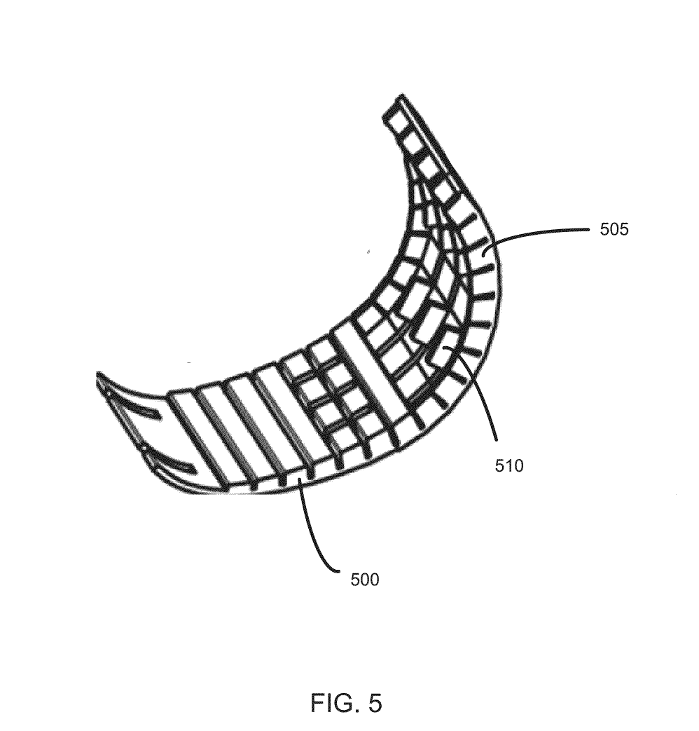

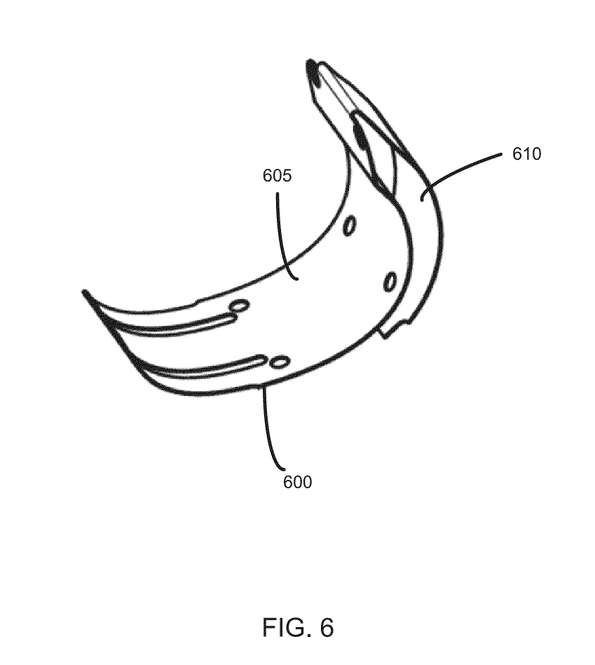

The exemplary outer member 400 can also include one or more ribs 415. Exemplary ribs provide spacing between the inner member 300 and the outer member 400, and provide space so that that the inner member 300 and the outer member 400 remain in a spaced apart orientation with respect to one another that is approximately equal to the size of the ribs 415. In the exemplary embodiment, the antenna (described with respect to FIG. 6) wraps around inner member 300 and the outer member 400 such that the ground plane of the antenna is disposed inside the inner member 300 and the transmitting elements of the antenna are disposed on the outside of the outer member 400. The exemplary ribs 415 provide space between the ground plane and the transmitting portions of the antenna, which, as one of skill in the art would understand, can improve antenna performance. The exemplary ribs 415 can also be used to engage with a fill member 500 (described with respect to FIG. 5) and can serve to align the fill member 500 to the outer member 400, as well as hold the fill member 500 in place with respect to the outer member 400.

The outer member 400 can also include aligning members 420. The exemplary aligning members 420 are configured to interface with the aperture 335 of the inner member 400. The interaction between the aligning members 420 and the aperture 335 is described above with respect to FIG. 3.

Turning now to FIG. 5, a perspective view of an exemplary fill member 500 is provided. The exemplary fill member 500 may be made from thermoplastic elastomer, but in alternative exemplary embodiments, may be formed from any material that provides sufficient strength and flexibility for the particular application. By way of example only, the fill member 500 may be made from cloth, canvas, rubber, or silicone.

In an exemplary embodiment, the fill member 500 is configured to fill the space between the inner member 300 and the outer member 400. The exemplary fill member 500 is thicker on the end closest to the flat portion of the inner member 300 and thinner on the opposing end. The exemplary fill member need not be solid throughout, but may include various ridges 505 and recessions such as those shown in FIG. 5. The ridges 505 and recessions allow the fill member 500 to provide a substantial volume of material, yet stay flexible without significantly increasing the stiffness of the support assembly 200.

The exemplary fill member 500 can also include rib interfaces 510. The rib interfaces 510 can be configured to receive the ribs 415 from the outer member 400 so as to assist in holding the fill member 500 in place with respect to the outer member 400.

Turning now to FIG. 6, a perspective view of an exemplary antenna 600 is shown. The antenna 600 is configured to fit around the support assembly 200. The exemplary antenna 600 is a flexible printed circuit. The exemplary antenna 600 has a ground plane portion 605 that is disposed adjacent the inner member 300 and a transmitting portion 610 that is disposed adjacent the outer member 400. The transmitting portion 610 can have antenna traces designed to transmit in radiofrequency bands, and as one of skill in the art would understand, the arrangement of the antenna traces can depend on the specific radiofrequency bands over which a given antenna will transmit. By way of example, U.S. patent application Ser. No. 14/011,352, the disclosure of which is incorporated herein by references, describes an antenna design that is suitable for use with exemplary embodiment support assembly described herein.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A support structure for a band for a wearable device, comprising:
an inner member comprising a curved portion and a flat portion;
an outer member comprising a curved portion and an interface member attached to the flat portion of the inner member;
the inner member and the outer member forming a cavity between them; and
a fill member configured to fill the cavity between the inner member and the outer member.

2. The support structure of claim 1, further comprising a band surrounding the support structure.

3. The support structure of claim 1, wherein the outer member comprises ribs that maintain the cavity between the inner member and the outer member.

4. The support structure of claim 1, wherein the outer member comprises ribs that engage the fill member.

5. The support structure of claim 1, further comprising an antenna wrapped around the inner member and the outer member.

6. The support structure of claim 5, wherein the antenna further comprises a first portion comprising a ground plane and a second portion comprising transmitting elements, and wherein the ground plane is substantially disposed on the inner member, and the transmitting elements are substantially disposed on the outer member.

7. The support structure of claim 1, wherein the wearable device is configured to be worn on a wrist.

8. The support structure of claim 1, wherein the outer member comprises a rib interface configured to engage with an aperture on the inner member.

9. The support structure of claim 1, wherein the inner member further comprises an aperture that increases the flexibility of the inner member.

10. A support structure for a band for a wearable device, comprising:
a band configured to allow the device to be worn, the band comprising a support assembly, the support assembly comprising:
an inner member coupled to an outer member, the inner member and the outer member disposed in a spaced apart relationship and coupled together on one end; and
an antenna disposed on the inner member and the outer member,
wherein the ground plane of the antenna is disposed on the inner member and the transmitting elements of the antenna are disposed on the outer member.

11. The support structure for a band for a wearable device of claim 10, wherein the outer member further comprises ribs that maintain a minimum distance between the inner member and the outer member.

12. The support structure for a band for a wearable device of claim 10, further comprising a fill member to occupy a cavity between the inner member and the outer member.

13. The support structure for a band for a wearable device of claim 10, wherein the outer member comprises ribs that engage the fill member.

14. The support structure for a band for a wearable device of claim 10, wherein the wearable device is configured to be worn on a wrist.

15. The support structure for a band for a wearable device of claim 10, wherein the outer member comprises a rib configured to engage with an aperture on the inner member.

16. The support structure for a band for a wearable device of claim 10, wherein the inner member further comprises an aperture that increases the flexibility of the inner member.

17. The support structure for a band for a wearable device of claim 10, wherein the inner member and the outer member are coupled only along one edge.

18. The support structure for a band for a wearable device of claim 10, wherein the inner member and the outer member can move laterally with respect to one another.

19. The support structure for a band for a wearable device of claim 10, wherein the antenna comprises a flexible printed circuit board.

20. A support structure for a band for a wearable device, comprising:
a band configured to allow the device to be worn, the band comprising a support assembly, the support assembly comprising:
an inner member coupled to an outer member, the inner member and the outer member disposed in a spaced apart relationship and coupled together along only one edge such that they can move laterally with respect to one another;
the outer member comprising ribs that maintain a minimum distance between the inner member and the outer member and define a cavity, the cavity comprising a fill member that engages the ribs;
a flexible printed circuit board comprising an antenna disposed on the inner member and the outer member, wherein a ground plane of the antenna is disposed on the inner member and transmitting elements of the antenna are disposed on the outer member.
